(19) United States
(12) Patent Application Publication
(10) Pub. No.: US 2025/0200187 A1
(43) Pub. Date: Jun. 19, 2025

(54) INFORMATION PROCESSING APPARATUS AND CONTROL METHOD

(71) Applicant: Lenovo (Singapore) Pte. Ltd., Singapore (SG)

(72) Inventors: Masashi Nishio, Kanagawa (JP); Eri Shimizu, Kanagawa (JP)

(73) Assignee: Lenovo (Singapore) Pte. Ltd., Singapore (SG)

(21) Appl. No.: 18/948,409

(22) Filed: Nov. 14, 2024

(30) Foreign Application Priority Data
Dec. 15, 2023 (JP) 2023-212196

(51) Int. Cl. G06F 21/57; G06F 21/32

(52) U.S. Cl. CPC G06F 21/575; G06F 21/32; G06F 2221/034

(57) ABSTRACT

An information processing apparatus includes: a memory which temporarily stores a program of a system; a first processor which executes face authentication processing to detect an area of a face image with a face captured therein from a captured image captured by an imaging unit and to authenticate whether or not a person of the detected face image is a registered user based on information on the detected face image and information on a face image of the registered user; and a second processor which executes the program of the system to boot the system from a standby state based on a fact that authentication by the face authentication processing is successful.

### CROSS-REFERENCE TO RELATED APPLICATIONS

This application claims priority to Japanese Patent Application No. 2023-212196 filed on Dec. 15, 2023, the contents of which are hereby incorporated herein by reference in their entirety.

### TECHNICAL FIELD

The present invention relates to an information processing apparatus and a control method.

### BACKGROUND

There is an information processing apparatus which makes a transition to a usable state when a person approaches or to a standby state in which functions except some of the functions are stopped when the person moves away. For example, in Japanese Unexamined Patent Application Publication No. 2016-148895, it is detected whether a person is approaching or has moved away using an infrared sensor.

In recent years, with the development of computer vision and the like, detection accuracy when detecting a face from an image has been getting higher. Therefore, person detection by face detection is also becoming common instead of person detection by the infrared sensor. Further, after booting the information processing apparatus, login authentication is performed to authorize whether or not a person is a registered user. As this authentication method, face authentication is starting to be used. For example, when a person approaches, the information processing apparatus is booted by detecting a face of the person, and when the person is a registered user as a result of performing login authentication such as face authentication after that, login to the system is allowed and the information processing apparatus makes a transition to the usable state.

In the method of booting the information processing apparatus by face detection as described above, the information processing apparatus is booted up even when any person other than the registered user approaches. In view of the above, it is considered a method of further determining whether or not the person is the registered user by face authentication when the person is detected by the face detection to boot the information processing apparatus only when the person is determined to be the registered user. However, in the standby state before bootup, since it is necessary to keep power consumption low, the recognition rate decreases at the time of face authentication. When the recognition rate decreases, there is a possibility that an unregistered person may be erroneously determined to be a registered user even with a low probability. Therefore, when the unregistered person is in front of the information processing apparatus for a long time, there is a concern that the erroneous determination may occur during that time to boot the information processing apparatus.

### SUMMARY

One or more embodiments of the present invention provide an information processing apparatus and a control method capable of booting the system properly when a registered user approaches.

An information processing apparatus according to one or more embodiments of the present invention includes: a memory which temporarily stores a program of a system; a first processor which executes face authentication processing to detect an area of a face image with a face captured therein from a captured image captured by an imaging unit and to authenticate whether or not a person of the detected face image is a registered user based on information on the detected face image and information on a face image of the registered user; and a second processor which executes the program of the system to boot the system from a standby state based on the fact that authentication by the face authentication processing is successful, wherein when the authentication by the face authentication processing is unsuccessful, the first processor executes the face authentication processing again, and when executing the face authentication processing repeatedly due to failures of the authentication by the face authentication processing, the first processor stops the face authentication processing based on the number of times the face authentication processing is executed.

The above information processing apparatus may be such that the first processor executes person detection processing to detect the presence of a person by detecting the area of the face image with the face captured therein from the captured image, and when the presence of a person is detected by the person detection processing, the first processor moves from the person detection processing to the face authentication processing, and the first processor stops the face authentication processing based on the fact that the number of times the face authentication processing is executed has reached a preset number of times since the presence of the person was detected by the person detection processing.

The above information processing apparatus may also be such that, when stopping the face authentication processing due to failures of the authentication by the face authentication processing, the first processor moves to the person detection processing.

The above information processing apparatus may further be such that, when the presence of a person is detected by the person detection processing after stopping the face authentication processing, the first processor determines whether or not the number of persons that exist changes, and when determining that the number of persons that exist changes, the first processor moves from the person detection processing to the face authentication processing again.

Further, the above information processing apparatus may be such that, when the presence of the person is no longer detected by the person detection processing after stopping the face authentication processing, the first processor continues the person detection processing without moving to the face authentication processing, and when the presence of a person is detected, the first processor moves from the person detection processing to the face authentication processing.

Further, the above information processing apparatus may be such that the person detection processing is processing lower in power consumption than the face authentication processing.

Further, the above information processing apparatus may be such that a frame rate when detecting the area of the face image with the face captured therein from the captured image in the person detection processing is lower than that in the face authentication processing, and when moving from the person detection processing to the face authentication processing and from the face authentication processing to the person detection processing, the first processor switches the frame rate.

Further, the above information processing apparatus may be such that the second processor executes login authentication processing to authenticate whether or not to allow login to the system based on the face image detected from the captured image captured by the imaging unit after booting the system, and the face authentication processing executed in the standby state before booting the system is processing lower in power consumption than that in the login authentication processing.

Further, the above information processing apparatus may be such that the frame rate when detecting the area of the face image with the face captured therein from the captured image in the face authentication processing executed in the standby state before booting the system is lower than that in the login authentication processing.

Further, the above information processing apparatus may be such that the first processor executes user registration processing to register information based on a face image of a user using the information processing apparatus.

Further, a control method according to the second aspect of the present invention is a control method for an information processing apparatus including a memory which temporarily stores a program of a system, a first processor, and a second processor, the control method including: a step of causing the first processor to execute face authentication processing to detect an area of a face image with a face captured therein from a captured image captured by an imaging unit and to authenticate whether or not a person of the detected face image is a registered user based on information on the detected face image and information on a face image of the registered user; a step of causing the second processor to execute the program of the system to boot the system from a standby state based on the fact that authentication by the face authentication processing is successful; a step of causing the first processor to execute the face authentication processing again when the authentication by the face authentication processing is unsuccessful; and a step in which, when executing the face authentication processing repeatedly due to failures of the authentication by the face authentication processing, the first processor stops the face authentication processing based on the number of times the face authentication processing is executed.

The above-described aspects of the present invention can boot the system properly when the registered user approaches.

### BRIEF DESCRIPTION OF THE DRAWINGS

FIGS. 1A-1C are diagrams for describing an overview of HPD processing of an information processing apparatus according to one or more embodiments.

FIG. 2 is a diagram illustrating an example of a person detection range of the information processing apparatus according to one or more embodiments.

FIG. 3 is a flowchart illustrating an overview of HPD processing according to one or more embodiments.

FIG. 4 is a perspective view illustrating an appearance configuration example of the information processing apparatus according to one or more embodiments.

FIG. 5 is a diagram illustrating an example of the hardware configuration of the information processing apparatus according to one or more embodiments.

FIG. 6 is a diagram illustrating an example of the functional configuration of the information processing apparatus according to one or more embodiments.

FIG. 7 is a flowchart illustrating an example of HPD processing in a standby state according to one or more embodiments.

### DETAILED DESCRIPTION

Embodiments of the present invention will be described below with reference to the accompanying drawings.

First, the overview of an information processing apparatus according to one or more embodiments will be described. An information processing apparatus 1 according to one or more embodiments is, for example, a laptop (clamshell) PC (Personal Computer). Note that the information processing apparatus 1 may also be any other type of information processing apparatus such as a desktop PC, a tablet PC, or a smartphone.

The information processing apparatus 1 can make a transition, as the operating state of the system, at least between a normal operating state (power-on state) and a standby state. The normal operating state is an operating state capable of executing processing without being particularly limited, which corresponds, for example, to SO state defined in the ACPI (Advanced Configuration and Power Interface) specification. The standby state is a state in which part of system processing is limited. For example, the standby state may be the standby state or a sleep state, Modern Standby in Windows (registered trademark), or a state corresponding to S3 state (sleep state) defined in the ACPI specification. For example, the standby state is an operating state lower in power consumption than the normal operating state.

In the following, a transition of the system operating state from the standby state to the normal operating state may also be called “boot.” Since the standby state is typically lower in the activation level of the operation than the normal operating state, the boot of the system of the information processing apparatus 1 leads to the activation of the operation of the system in the information processing apparatus 1.

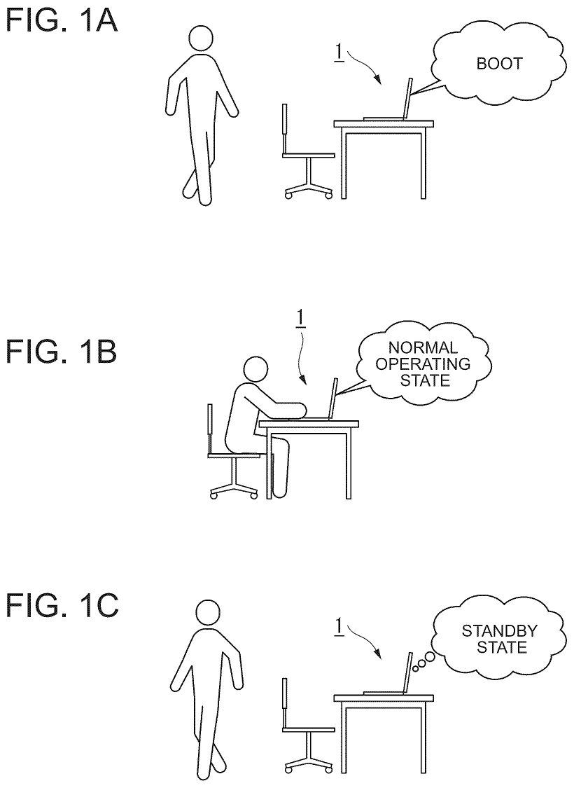

FIGS. 1A-1C is a diagram for describing an overview of HPD processing of the information processing apparatus 1 according to one or more embodiments. The information processing apparatus 1 detects a person (that is, a user) present in the neighborhood of the information processing apparatus 1. This processing to detect the presence of a person is called HPD (Human Presence Detection) processing. The information processing apparatus 1 detects the presence or absence of a person by the HPD processing to control the operating state of the system of the information processing apparatus 1 based on the detection result. For example, as illustrated in FIG. 1A, when detecting a change from a state where no person is present in front of the information processing apparatus 1 (Absence) to a state where a person is present (Presence), that is, when detecting that a person has approached the information processing apparatus 1 (Approach), the information processing apparatus 1 determines that the user has approached, and automatically boots the system to make a transition to the normal operating state. Further, in a state where a person is present in front of the information processing apparatus 1 (Presence) as illustrated in FIG. 1B, the information processing apparatus 1 determines that the user is present, and continues the normal operating state. Then, as illustrated in FIG. 1C, when detecting a change from the state where the person is present in front of the information processing apparatus 1 (Presence) to the state where no person is present (Absence), that is, when detecting that the person has left the information processing apparatus 1 (Leave), the information processing apparatus 1 determines that the user has left and causes the system to make a transition to the standby state.

The information processing apparatus 1 detects the presence of a person in a predetermined forward range.

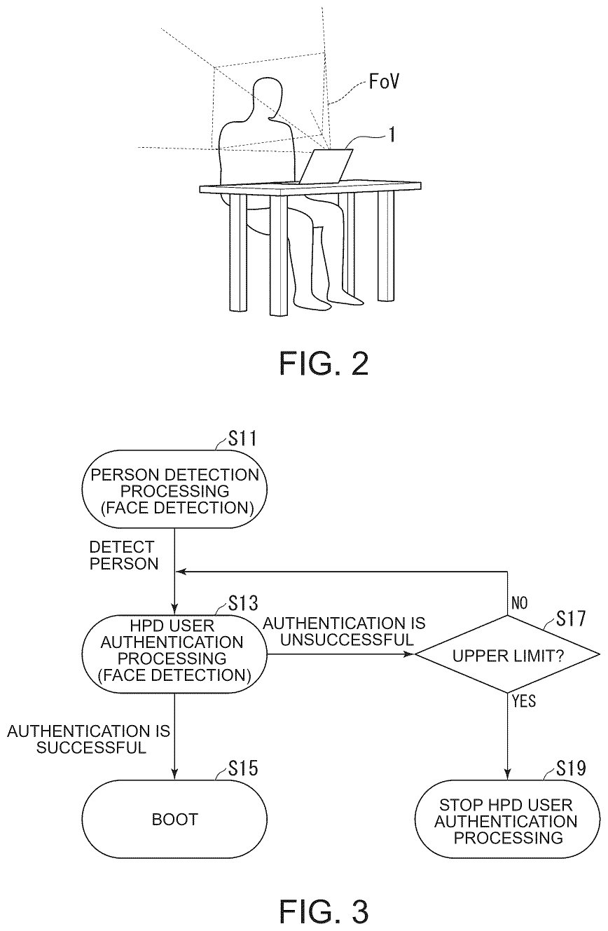

FIG. 2 is a diagram illustrating an example of a person detection range of the information processing apparatus 1 according to one or more embodiments. In the illustrated example, a detection range FoV (Field of View: detection viewing angle) in front of the information processing apparatus 1 is a person detectable range. For example, the information processing apparatus 1 detects an area of a face image (hereinafter called a “face area”) with a face captured therein from a captured image captured by imaging forward (on the front side) to detect a person present in front of the information processing apparatus 1. The detection range FoV corresponds to an imaging angle of view at which the information processing apparatus 1 captures an image. When the face area is detected from the captured image, the information processing apparatus 1 determines that a person is present. On the other hand, when no face area is detected from the captured image, the information processing apparatus 1 determines that no person is present.

Here, upon booting the system from the standby state only by detecting the face area from the captured image in the HPD processing, the information processing apparatus 1 is booted up even when any person other than an authorized user using the information processing apparatus 1 approaches. Therefore, when determining that a person is present by detecting the face area from the captured image in the standby state, the information processing apparatus 1 further determines (authenticates) whether or not the person is a registered user (an authorized user using the information processing apparatus 1). When determining that the person is the registered user, the information processing apparatus 1 boots the system from the standby state. On the other hand, when determining that the person is not the registered user, the information processing apparatus 1 continues the standby state without booting the system.

The registered user is a user preregistered as a user using the information processing apparatus 1 (that is, as an authorized user). The information processing apparatus 1 registers, as a user ID of the authorized user, feature information based on a face image of this authorized user to authorize whether or not the detected person in the HPD processing is the registered user. This user ID used for authentication in the HPD processing is called an “HPD user ID” below. Further, the authentication of whether or not the detected person in the HPD processing is the registered user using the HPD user ID is called “HPD user authentication” below.

The HPD user ID may also be registered using a user registration app (application program) in the information processing apparatus 1. For example, the information processing apparatus 1 may execute the user registration app so that a face image of a user himself/herself is captured in the running app with a user operation to register (store), as the HPD user ID, feature information based on the captured face image. Further, the registration of this HPD user ID may also be done by the information processing apparatus 1 at a predetermined timing without any user operation. For example, when booting the system, the information processing apparatus 1 may also register (store), as the HPD user ID, feature information based on a face image (for example, a face image when facing forward) detected within a predetermined time (for example, within five seconds) since the login authentication to allow login to the system was successful.

As the method of system login authentication, there are password authentication to authenticate a user by the user entering a password on the keyboard, PIN authentication to authenticate the user by the user entering a PIN (Personal Identification Number), face authentication to authenticate the user by the face of the user, fingerprint authentication to authenticate the user with the user's fingerprint, and the like.

Here, when face authentication is used in the system login authentication, since the system is operating and highly accurate face authentication is required, high power consumption is allowed. On the other hand, when HPD user authentication is performed, since the system is in the standby state, it is desirable to reduce power consumption as much as possible. For example, in the case of face authentication in the login authentication, a captured image (IR image) captured with an IR (Infrared Rays) camera is used, while in a case of HPD user authentication in the standby state, a captured image (RGB image) captured with an RGB camera (normal visible light camera) lower in power consumption than the IR camera is used. Further, the image capturing frame rate in the HPD user authentication is set lower than the image capturing frame rate in the login authentication.

Thus, since the HPD user authentication in the standby state needs to keep power consumption lower than the face authentication in the login authentication, the recognition rate of the face authentication decreases. In the case where the recognition rate decreases, even when a registered person is correctly determined to be a registered user with a probability of about 80%, there is a possibility that even an unregistered person may be erroneously determined to be the registered user with a probability of about 0% to 40%. When the unregistered person exists for a long time, if even one erroneous determination occurs, since the system will be booted, there is a concern that the system will be booted by mistake even if the person is the unregistered person.

Therefore, when the authentication by the HPD user authentication is successful, the information processing apparatus 1 according to one or more embodiments boots the system from the standby state, while when the authentication by the HPD user authentication is unsuccessful, the information processing apparatus 1 continues the HPD user authentication, but will limit the number of times to repeat the HPD user authentication if authentication failures continue.

Referring to FIG. 3, an overview of HPD processing performed by the information processing apparatus 1 to boot the system when detecting the registered user using the HPD user authentication will be described. FIG. 3 is a flowchart illustrating the overview of HPD processing according to one or more embodiments.

The information processing apparatus 1 executes person detection processing to detect the presence of a person by detecting a face area from a captured image obtained by imaging the detection range FoV (see FIG. 2) in the standby state (face detection) (step S11). When detecting the presence of a person in step S11, the information processing apparatus 1 proceeds to step S13.

In step S13, the information processing apparatus 1 moves from the person detection processing to HPD user authentication processing. In the HPD user authentication processing, the information processing apparatus 1 detects the face area from the captured image obtained by imaging the detection range FoV (see FIG. 2) (face detection), and determines (authenticates) whether or not the detected person is a registered user based on feature information on the detected face image and the registered HPD user ID (feature information on the face image of the registered user). When the authentication in step S13 is successful (when determining that the detected person is the registered user), the information processing apparatus 1 boots the system (step S15).

On the other hand, when the authentication in step S13 is unsuccessful (when determining that the detected person is not the registered user), the information processing apparatus 1 proceeds to step S17.

In step S17, the information processing apparatus 1 determines whether or not the number of times the HPD user authentication processing is executed due to authentication failures has reached the upper limit. When determining that the upper limit has not been reached (NO), the information processing apparatus 1 returns to step S13 to execute the HPD user authentication processing again. On the other hand, when determining that the number of times the HPD user authentication processing is executed due to authentication failures has reached the upper limit (YES), the information processing apparatus 1 stops the HPD user authentication processing (step S19). The upper limit number of times to stop the HPD user authentication processing is preset, which is “ten times” as an example. Note that the information processing apparatus 1 executes the person detection processing after stopping the HPD user authentication processing.

Thus, when the authentication by the HPD user authentication processing is unsuccessful, the information processing apparatus 1 executes the HPD user authentication processing again, and when executing the HPD user authentication processing repeatedly due to authentication failures, the information processing apparatus 1 stops the HPD user authentication processing based on the fact that the number of executions has reached the upper limit (the preset number of times).

Thus, the information processing apparatus 1 can prevent an unregistered person from being erroneously determined to be the registered user and hence the system from being unintentionally booted. Therefore, the information processing apparatus 1 can boot the system properly when the registered user approaches.

Next, the configurations of the information processing apparatus 1 according to one or more embodiments will be described in detail.

### [Appearance Configuration of Information Processing Apparatus]

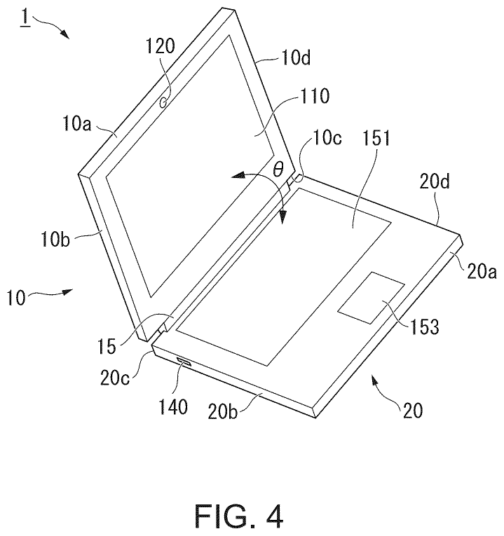

FIG. 4 is a perspective view illustrating an appearance configuration example of the information processing apparatus 1 according to one or more embodiments.

The information processing apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “e” in FIG. 4.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c toward the side face 20a is referred to as “front.” The right hand and the left hand in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle θ=0°) is referred to as a “closed state.” The faces of the first chassis 10 and the second chassis 20 on the face-to-face sides in the closed state are referred to as respective “inner faces,” and the faces opposite to the inner faces are referred to as “outer faces.” Further, a state opposite to the closed state, where the first chassis 10 and the second chassis 20 are open, is referred to as an “open state.”

The appearance of the information processing apparatus 1 in FIG. 4 illustrates an example of the open state. The open state is a state where the side face 10a of the first chassis 10 and the side face 20a of the second chassis 20 are separated. In the open state, the respective inner faces of the first chassis 10 and the second chassis 20 appear. The open state is one of states when the user uses the information processing apparatus 1, and the information processing apparatus 1 is often used in a state where the open angle is typically about θ=100° to 130°. Note that the range of open angles θ to be the open state can be set arbitrarily according to the range of angles rotatable by the hinge mechanism 15 or the like.

A display unit 110 is provided on the inner face of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner face of the first chassis 10. For example, the imaging unit 120 is arranged on the side of the side face 10a in the peripheral area of the display unit 110. Note that the position at which the imaging unit 120 is arranged is just an example, and the imaging unit 120 may also be arranged at any other position as long as the imaging unit 120 can image a direction (frontward) to face the inner face of the first chassis 10.

In the open state, the imaging unit 120 images a predetermined imaging range in the direction (frontward) to face the inner face of the first chassis 10. The predetermined imaging range is a range of angles of view defined by an image sensor included in the imaging unit 120 and an optical lens provided in front of the imaging surface of the image sensor, which corresponds to the person (face) detection range FoV illustrated in FIG. 2. For example, the imaging unit 120 can capture an image including a person (for example, the user) present in front of the information processing apparatus 1.

Further, a power button 140 is provided on the side face 20b of the second chassis 20. The power button 140 is an operating element used by the user to give an instruction to power on or power off, the transition from the standby state to the normal operating state, the transition from the normal operating state to the standby state, or the like. Further, a keyboard 151 and a touch pad 153 are provided on the inner face of the second chassis 20 as an input device to accept user operation input. Note that a touch sensor may also be provided as the input device instead of or in addition to the keyboard 151 and the touch pad 153, or a mouse and an external keyboard may be connected. When the touch sensor is provided, an area corresponding to the display surface of the display unit 110 may be constructed as a touch panel to accept operations. Further, a microphone used to input voice may be included in the input device.

### [Hardware Configuration of Information Processing Apparatus]

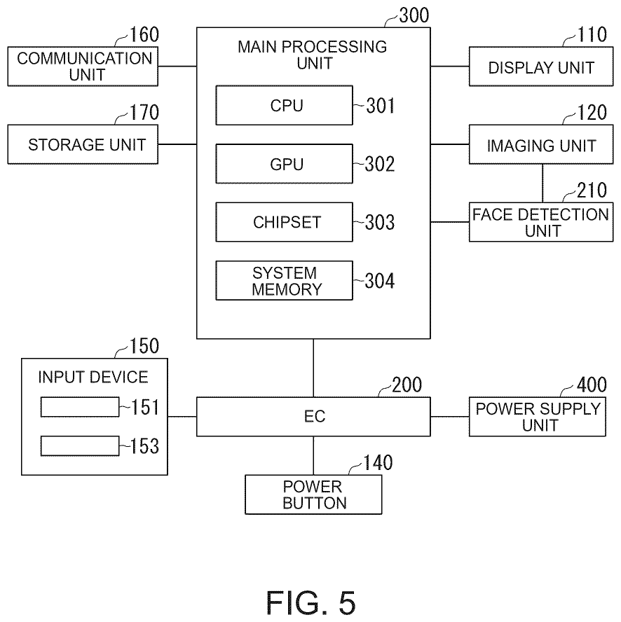

FIG. 5 is a schematic block diagram illustrating an example of the hardware configuration of the information processing apparatus 1 according to one or more embodiments. The information processing apparatus 1 is configured to include the display unit 110, the imaging unit 120, the power button 140, an input device 150, a communication unit 160, a storage unit 170, an EC (Embedded Controller) 200, a face detection unit 210, a main processing unit 300, and a power supply unit 400. The display unit 110 displays display data (images) generated based on system processing executed by the main processing unit 300, processing of an application program(s) running on the system processing, and the like.

The imaging unit 120 captures an image of an object within a predetermined angle of view (for example, within the detection range FoV illustrated in FIG. 2) in a direction (frontward) to face the inner face of the first chassis 10, and outputs the captured image to the face detection unit 210 and the main processing unit 300. For example, the imaging unit 120 includes an RGB camera and an IR (Infrared Rays) camera. The RGB camera is a normal camera to capture images based on visible light. The IR camera is a camera to capture images using infrared light, which irradiates infrared rays upon imaging to capture an image based on the infrared rays reflected on the object.

Since the IR camera irradiates infrared rays, for example, upon imaging, power consumption upon imaging is higher than that of the RGB camera. Therefore, for example, the RGB camera is used instead of the IR camera when detecting the face area and performing face authentication from a captured image in the standby state because it is desired to reduce standby power as much as possible. On the other hand, for example, when detecting the face area and performing face authentication from a captured image in login authentication, the IR camera is used to further improve authentication accuracy. Note that both the IR camera and the RGB camera may also be used when performing login authentication by face authentication.

The power button 140 outputs, to the EC 200, operation signals according to user operations. The input device 150 is an input unit for accepting user input, which is configured to include, for example, the keyboard 151 and the touch pad 153. In response to accepting operations on the keyboard 151 and the touch pad 153, the input device 150 outputs, to the EC 200, operation signals indicative of the operation contents.

The communication unit 160 is connected to other devices communicably through a wireless or wired communication network to transmit and receive various data. For example, the communication unit 160 is configured to include a wired LAN interface such as the Ethernet (registered trademark), a wireless LAN interface such as Wi-Fi (registered trademark), and the like.

The storage unit 170 is configured to include storage media, such as an HDD (Hard Disk Drive) or an SSD (Solid State Drive), a RAM (Random Access Memory), a ROM (Read Only Memory), and the like. The storage unit 170 stores an OS, device drivers, various programs such as applications, and various data acquired by the operation of the programs.

The power supply unit 400 supplies power to each unit of the information processing apparatus 1 according to the operating state of each unit. The power supply unit 400 includes a DC (Direct Current)/DC converter. The DC/DC converter converts the voltage of DC power, supplied from an AC (Alternate Current)/DC adapter or a battery (battery pack), to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM, a ROM, an I/O (Input/Output) logic circuit, and the like. The CPU of the EC 200 reads a control program (firmware) prestored in the own ROM and executes the read control program to fulfill the functionality. The EC 200 operates independently of the main processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The face detection unit 210 is configured to include a processor to process image data of a captured image captured by the imaging unit 120. The face detection unit 210 acquires the image data of the captured image captured by the imaging unit 120, and temporarily stores the acquired image data in a memory. The memory in which the image data is stored may be a system memory 304, or an unillustrated memory in the face detection unit 210.

The face detection unit 210 processes the image data of the captured image acquired from the imaging unit 120, and performs face detection processing to detect a face area from the captured image, face authentication processing to authenticate a face image in the detected face area, and the like in order to execute HPD processing to detect the presence of a person and authenticate whether or not the person is a registered user. For example, in the case of HPD processing in the standby state, the face detection unit 210 detects a face area from a captured image captured with the RGB camera of the imaging unit 120 to perform person detection processing to detect the presence of a person. Further, in the case of HPD processing in the standby state, when the presence of a person is detected by the person detection processing, the face detection unit 210 detects the face area from the captured image captured with the RGB camera of the imaging unit 120 to perform HPD user authentication processing by the face authentication processing to authenticate whether or not the detected person is the registered user.

Further, when booting the system from the standby state, the face detection unit 210 performs face detection processing to detect a face area from a captured image captured with the IR camera of the imaging unit 120 and face authentication processing for system login authentication. Further, even when performing HPD processing in the normal operating state, the face detection unit 210 may also perform processing using the captured image captured with the IR camera of the imaging unit 120.

The face detection unit 210 transmits, to a chipset 303 of the main processing unit 300, the detection result by the HPD processing, the authentication result of the face authentication processing for login, and the like. The functional configuration related to HPD processing will be described in detail later.

The main processing unit 300 is configured to include a CPU (Central Processing Unit) 301, a GPU (Graphic Processing Unit) 302, the chipset 303, and the system memory 304, where processing of various application programs is executable on the OS (Operating System) by system processing based on the OS.

The CPU 301 executes processing by a BIOS, processing by the OS, processing by application programs running on the OS, and the like. The CPU 301 controls the operating state of the system based on instructions from the chipset 303 and the like. For example, the CPU 301 executes boot processing to boot the system from the standby state. Further, after the system is booted from the standby state, the CPU 301 executes login authentication processing to perform user authentication to authenticate whether or not to allow login to the system, and when the authentication is successful, the CPU 301 makes the transition to the normal operating state. For example, in the login authentication, the CPU 301 executes authentication processing by face authentication. Note that, in the login authentication, the CPU 301 may also execute authentication processing other than the face authentication (for example, password authentication, PIN authentication, or fingerprint authentication).

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, in the HPD processing, the chipset 303 acquires the detection result of the person detection processing, the authentication result of the HPD user authentication processing, the authentication result of the face authentication processing for login, and the like from the face detection unit 210 to give instructions about the operating state of the system and the like based on the detection results.

The system memory 304 is used as a reading area of a program executed by the CPU 301 and a working area to write processed data. Further, the system memory 304 temporarily stores image data of captured images captured by the imaging unit 120.

Note that the CPU 301, the GPU 302, and the chipset 303 may also be integrated as one processor, or some or each of them may be configured as an individual processor, respectively. For example, in the normal operating state, the CPU 301, the GPU 302, and the chipset 303 are all operating, but in the standby state, only at least some of the functions of the chipset 303 are operating. In the standby state, at least only functions required for HPD processing upon bootup are operating.

### [Functional Configuration of Information Processing Apparatus]

Next, a functional configuration in which the information processing apparatus 1 controls the operating state of the system by the HPD processing will be described.

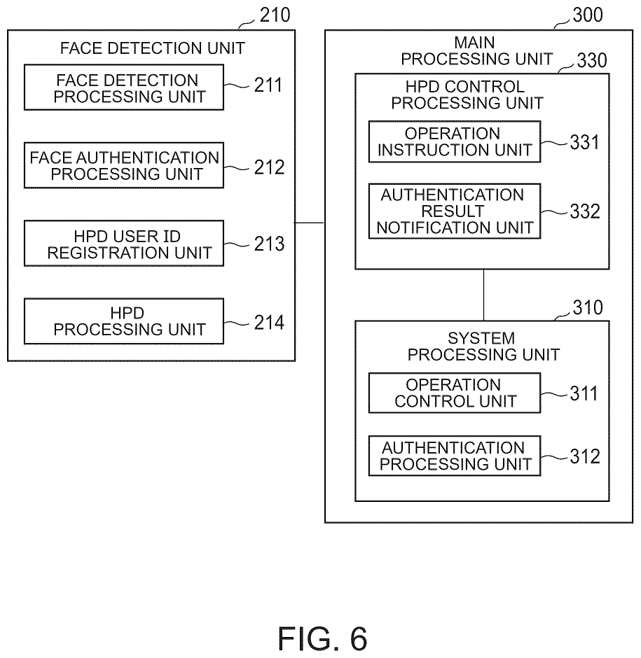

FIG. 6 is a block diagram illustrating an example of the functional configuration of the information processing apparatus 1 according to one or more embodiments. The information processing apparatus 1 includes the face detection unit 210, a system processing unit 310, and an HPD control processing unit 330. The face detection unit 210 corresponds to the face detection unit 210 illustrated in FIG. 5, which is a functional component implemented by executing a program in the face detection unit 210. The system processing unit 310 and the HPD control processing unit 330 are functional components implemented by the main processing unit 300 illustrated in FIG. 5 executing the OS and a program running on the OS. For example, the system processing unit 310 is a functional component implemented by the CPU 301 executing the OS program. Further, the HPD control processing unit 330 is a functional component implemented by the chipset 303 executing the program running on the OS.

The face detection unit 210 includes a face detection processing unit 211, a face authentication processing unit 212, an HPD user ID registration unit 213, and an HPD processing unit 214. Further, the system processing unit 310 includes an operation control unit 311 and an authentication processing unit 312. Further, the HPD control processing unit 330 includes an operation instruction unit 331 and an authentication result notification unit 332.

The face detection processing unit 211 reads, from the system memory 304, image data of captured images captured by the imaging unit 120 at a given frame rate (at a given frequency) to detect a face area from each of the captured images, respectively. As the face detection method, any detection method using a face detection algorithm for detecting a face based on facial feature information, trained data (learned model) subjected to machine learning based on the facial feature information, a face detection library, or the like can be applied.

Further, the frame rate in a case where the imaging unit 120 captures images is controlled, for example, to 1 fps when performing the face detection processing to detect the presence of a person in the standby state, to 4 fps when performing the HPD user authentication processing to authenticate whether or not the detected person is the registered user, or the like. Further, the frame rate in a case where the imaging unit 120 captures images is controlled, for example, to 15 fps when booting the system from the standby state to perform login authentication processing, to 1 fps in the normal operating state after the login authentication processing, or the like.

For example, when performing the face detection processing to detect the presence of a person in the standby state, the face detection processing unit 211 detects a face area from a captured image (RGB image) captured at 1 fps using the RGB camera of the imaging unit 120. Further, for example, when performing the HPD user authentication processing, the face detection processing unit 211 detects a face area from a captured image (RGB image) captured at 4 fps using the RGB camera of the imaging unit 120. Further, for example, upon login authentication after bootup, the face detection processing unit 211 detects a face area from a captured image (IR image) captured at 15 fps using the IR camera of the imaging unit 120. Note that upon login authentication, the face detection processing unit 211 may also detect a face area from captured images (IR image and RGB image) captured by using the IR camera and the RGB camera of the imaging unit 120.

The face authentication processing unit 212 executes the face authentication processing to authenticate a face based on a face image in the detected face area. For example, when performing the HPD user authentication processing, the face authentication processing unit 212 performs face authentication processing based on feature information on a face image in a face area detected by the face detection processing unit 211 from a captured image (RGB image) captured at 4 fps using the RGB camera of the imaging unit 120, and feature information on the face image of the registered user registered as the HPD user ID.

Further, upon login authentication after bootup, the face authentication processing unit 212 performs face authentication by comparing a face image detected from a captured image (IR image) captured at 15 fps using the IR camera of the imaging unit 120 with the face image of the user preregistered as user information (account information) for logging in to the system. Specifically, for example, upon login authentication, the face authentication processing unit 212 performs face authentication by comparing feature information on the face image detected from the captured image (IR image) with feature information on the preregistered face image of the user.

Note that the face image of the user registered as user information (account information) for login is, for example, a face image detected from a captured image (IR image) captured at 15 fps using the IR camera of the imaging unit 120 on an image registration menu for face authentication in the system settings.

The HPD user ID registration unit 213 registers the HPD user ID used for HPD user authentication. For example, the HPD user ID registration unit 213 stores and registers the HPD user ID in the system memory 304 or an unillustrated memory in the face detection unit 210. As described above, the HPD user ID may be registered using the user registration app (application program) in the information processing apparatus 1, or by the information processing apparatus 1 at a predetermined timing without any user operation.

For example, the HPD user ID registration unit 213 registers, as the HPD user ID, feature information based on a face image of the user himself/herself captured in the user registration app with a user operation. Further, for example, the HPD user ID registration unit 213 may also register, as the HPD user ID, feature information based on a face image (for example, a face image when facing forward) detected by the face detection processing unit 211 within a predetermined time (for example, within five seconds) since the authentication by the login authentication processing was successful. Upon registering the HPD user ID, when the HPD user ID is not registered, the HPD user ID registration unit 213 newly registers an HPD user ID, while when the HPD user ID is already registered, the HPD user ID registration unit 213 updates the registered HPD user ID.

Based on the detection result of the face detection processing by the face detection processing unit 211, and the authentication result of the face authentication processing by the face authentication processing unit 212, the HPD processing unit 214 outputs information indicative of the detection results of the HPD processing. For example, in the standby state, the HPD processing unit 214 executes person detection processing to detect the presence of a person based on the detection result of the face detection processing by the face detection processing unit 211. When a face area is detected from a captured image (RGB image) by the face detection processing unit 211, the HPD processing unit 214 detects the presence of a person, that is, determines that a person is present (Presence=true). On the other hand, when no face area is detected from the captured image (RGB image) by the face detection processing unit 211, the HPD processing unit 214 determines that no person is present (Presence=false).

Further, when the presence of a person is detected by the person detection processing, the HPD processing unit 214 moves from the person detection processing to the HPD user authentication processing. For example, the HPD processing unit 214 determines whether or not the person of the detected face image is the registered user from the authentication result of the HPD user authentication of the face authentication processing performed by the face authentication processing unit 212 based on feature information on the face image in the face area detected from the captured image (RGB image) by the face detection processing unit 211, and the HPD user ID.

When the authentication result of the HPD user authentication is successful, the HPD processing unit 214 outputs, to the HPD control processing unit 330, Presence information indicating that the registered user is present in front of the information processing apparatus 1.

On the other hand, when the authentication result of the HPD user authentication is unsuccessful, the HPD processing unit 214 executes the HPD user authentication processing again, and when authentication failures continue, the HPD processing unit 214 repeatedly executes the HPD user authentication processing. However, when executing the HPD user authentication processing repeatedly due to authentication failures, the HPD processing unit 214 stops the HPD user authentication processing based on the fact that the number of times the HPD user authentication processing is executed has reached the preset number of times (for example, ten times). When stopping the HPD user authentication processing, the HPD processing unit 214 moves to the person detection processing.

Here, when stopping the HPD user authentication processing and moving to the person detection processing, the HPD processing unit 214 detects the presence of a person even as a person other than the registered user, that is, determines that a person is present (Presence=true). When the presence of a person is detected by the person detection processing after stopping the HPD user authentication processing, the HPD processing unit 214 determines whether or not the number of persons that exist changes. When determining that the number of persons that exist changes, since the registered user may exist, the HPD processing unit 214 moves from the person detection processing to the HPD user authentication processing again.

Note that, even in a case where the number of persons that exist changes, when the presence of the person is no longer detected, the HPD processing unit 214 determines that no person exists (Presence=false), and continues the person detection processing without moving to the HPD user authentication processing. Then, when the presence of a person is detected by the person detection processing again, the HPD processing unit 214 determines that a person is present (Presence=true), and moves from the person detection processing to the HPD user authentication processing.

Note that, when detecting that the registered user is present within the detection range FoV, the HPD processing unit 214 outputs the Presence information to the HPD control processing unit 330, while when detecting the presence of no person within the detection range FoV, the HPD processing unit 214 outputs, to the HPD control processing unit 330, Absence information indicating that no user is present in front of the information processing apparatus 1. Further, even when detecting the presence of a person within the detection range FoV but determining that the person is not the registered user, the HPD processing unit 214 outputs the Absence information to the HPD control processing unit 330.

When acquiring the Presence information output from the HPD processing unit 214 in the standby state, the operation instruction unit 331 gives an instruction to boot the system from the standby state. For example, the operation instruction unit 331 outputs, to the operation control unit 311, boot instruction information indicative of the instruction to boot the system from the standby state. Further, the operation instruction unit 331 does not give the instruction to boot the system while acquiring the Absence information from the HPD processing unit 214 in the standby state.

Note that, when acquiring the Absence information from the HPD processing unit 214 in the normal operating state, the operation instruction unit 331 gives an instruction to cause the system to make the transition to the standby state. For example, the operation instruction unit 331 outputs, to the operation control unit 311, standby instruction information indicative of the instruction to cause the system to make the transition to the standby state.

When acquiring the boot instruction information output from the operation instruction unit 331, the operation control unit 311 executes a program of the system to boot the system from the standby state. Further, after booting the system from the standby state, the operation control unit 311 raises a login authentication event. Then, the operation control unit 311 waits until the authentication is successful without allowing login. When the authentication is successful, the operation control unit 311 allows login, and makes the transition to the normal operating state.

Note that, when acquiring the standby instruction information output from the operation instruction unit 331 in the normal operating state, the operation control unit 311 causes the system to make the transition from the normal operating state to the standby state.

When the login authentication event occurs, the authentication processing unit 312 executes system login authentication processing. For example, the authentication processing unit 312 executes login authentication processing by face authentication, password authentication, PIN authentication, fingerprint authentication, or the like. For example, when executing the authentication processing by face authentication, the authentication processing unit 312 acquires the authentication result of the face authentication from the face detection unit 210 to execute the login authentication processing based on the acquired authentication result. When the authentication result of the login authentication processing is successful, the authentication processing unit 312 determines that the person is an authorized user, while when the authentication is unsuccessful, the authentication processing unit 312 determines that the person is not the authorized user.

Note that, in the case of password authentication or PIN authentication, the authentication processing unit 312 acquires, through the EC 200, an operation signal with a user operation on the keyboard 151. Then, based on the acquired operation signal, the authentication processing unit 312 executes authentication processing by comparing a password or a PIN entered with the user operation with a preregistered password or PIN. Further, in the case of fingerprint authentication, the authentication processing unit 312 executes the authentication processing by comparing a fingerprint acquired using an unillustrated fingerprint sensor with a preregistered fingerprint.

Note that the authentication result notification unit 332 may also notify the face detection unit 210 of the authentication result of the login authentication by the authentication processing unit 312. Then, the HPD user ID registration unit 213 of the face detection unit 210 may use, as a trigger, this notification of the authentication result of the login authentication to register, as the HPD user ID, feature information on a face image when facing forward within a predetermined time (for example, within five seconds) since the authentication by the login authentication processing was successful.

### [Operation by HPD Processing]

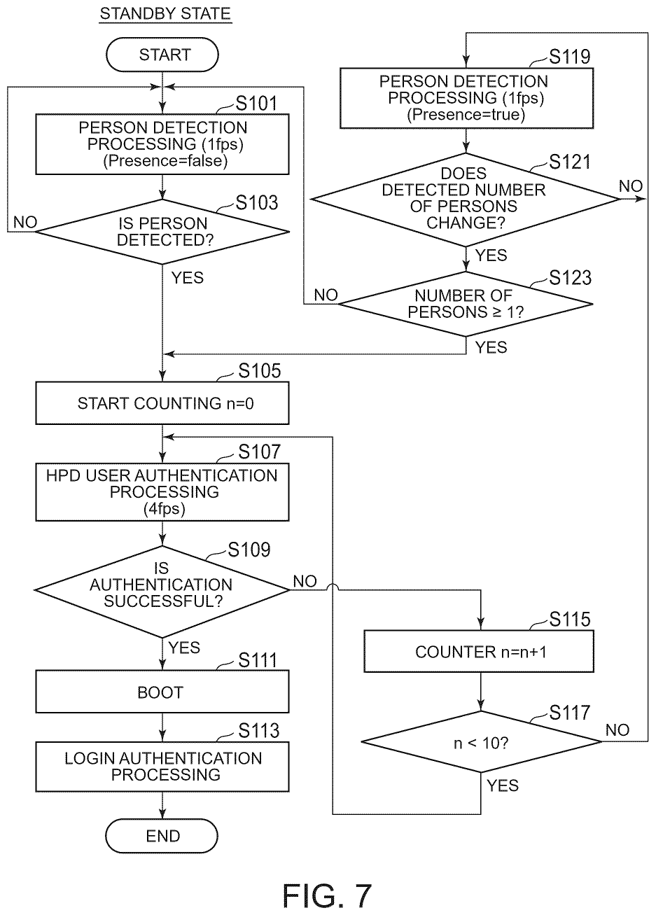

Referring next to FIG. 7, the operation of HPD processing in the standby state will be described. FIG. 7 is a flowchart illustrating an example of HPD processing in the standby state according to one or more embodiments.

(Step S101) The face detection unit 210 acquires a captured image (RGB image) captured using the RGB camera of the imaging unit 120 in the standby state. For example, the face detection unit 210 acquires a captured image (RGB image) captured at a frame rate of 1 fps by the imaging unit 120. Then, the face detection unit 210 detects a face area from a captured image (RGB image) frame by frame to execute person detection processing to detect the presence of a person. Here, it is assumed that no person is present initially in the standby state (Presence=false). Then, the face detection unit 210 proceeds to a process in step S103.

(Step S103) The face detection unit 210 determines whether or not the presence of a person is detected by the person detection processing in step S101. When detecting no face area from the captured image (RGB image), the face detection unit 210 determines that no person is present (Presence=false) (NO), and the face detection unit 210 returns to the process in step S101. On the other hand, when detecting a face area from the captured image (RGB image), the face detection unit 210 determines that a person is present (Presence=true) (YES), and the face detection unit 210 proceeds to a process in step S105.

(Step S105) The face detection unit 210 sets a counter that counts the number of execution times n of the HPD user authentication processing to “n=0” to start counting. Then, the face detection unit 210 proceeds to a process in step S107.

(Step S107) The face detection unit 210 switches the frame rate of the imaging unit 120 to 4 fps, and moves from the person detection processing to the HPD user authentication processing. The face detection unit 210 acquires a captured image (RGB image) captured at a frame rate of 4 fps by the imaging unit 120. The face detection unit 210 detects a face area from a captured image (RGB image) frame by frame to authenticate whether or not a person of the detected face image is the registered user based on feature information on the detected face image and the HPD user ID (the feature information on the face image of the registered user). Then, the face detection unit 210 proceeds to a process in step S109.

(Step S109) The face detection unit 210 determines whether or not the authentication of the authentication result by the HPD user authentication processing in step S107 is successful. When determining that the authentication is successful (YES), the face detection unit 210 proceeds to a process in step S111. On the other hand, when determining that the authentication is unsuccessful (NO), the face detection unit 210 proceeds to a process in step S115.

(Step S111) When determining that the authentication in step S109 is successful, the face detection unit 210 outputs Presence information to the HPD control processing unit 330. When acquiring the Presence information output from the face detection unit 210, the HPD control processing unit 330 outputs, to the system processing unit 310, boot instruction information indicative of the instruction to boot the system from the standby state as a boot instruction by the HPD processing. When acquiring the boot instruction information output from the HPD control processing unit 330, the system processing unit 310 executes the program of the system to boot the system from the standby state.

Note that, when a boot instruction other than the boot instruction by the HPD processing is given, the system processing unit 310 interrupts this HPD processing in the standby state, and boots the system from the standby state. The boot instruction other than boot instruction by the HPD processing is, for example, input to (operation on) an HID (Human Interface Device) such as the input device 150 or the power button 140.

(Step S113) After the system is booted from the standby state in step S111, the system processing unit 310 executes login authentication processing. For example, the system processing unit 310 executes authentication processing by face authentication, password authentication, PIN authentication, fingerprint authentication, or the like. When the authentication by the login authentication processing is successful, the system processing unit 310 allows login and causes the system to make the transition to the normal operating state.

(Step S115) When determining that the authentication in step S109 is unsuccessful, the face detection unit 210 adds 1 to the counter that counts the number of execution times n of the HPD user authentication processing (n=n+1), and the face detection unit 210 proceeds to a process in step S117.

(Step S117) The face detection unit 210 determines whether or not the number of execution times n of the HPD user authentication processing is less than ten (n<10). When determining that the number of execution times n of the HPD user authentication processing is less than ten (YES), the face detection unit 210 returns to the process in step S107 to execute the HPD user authentication processing again. On the other hand, when determining that the number of execution times n of the HPD user authentication processing has reached 10 (NO), the face detection unit 210 proceeds to a process in step S119.

(Step S119) The face detection unit 210 stops the HPD user authentication processing, switches the frame rate of the imaging unit 120 to 1 fps, and moves to the person detection processing. The face detection unit 210 acquires a captured image (RGB image) captured at a frame rate of 1 fps by the imaging unit 120. Then, the face detection unit 210 detects a face area from a captured image (RGB image) frame by frame and executes person detection processing to detect the presence of a person. Here, any person other than the registered user exists (Presence=true). Then, the face detection unit 210 proceeds to a process in step S121.

(Step S121) The face detection unit 210 determines whether or not the number of persons detected in step S119 changes. When determining that the number of persons does not change (NO), the face detection unit 210 returns to the process in step S119 to execute the person detection processing again. On the other hand, when determining that the detected number of persons changes (YES), the face detection unit 210 proceeds to a process in step S123.

(Step S123) The face detection unit 210 determines whether or not the number of persons detected in step S119 is one or more. When determining that the detected number of persons is one or more (YES), the face detection unit 210 returns to the process in step S105 because there is a possibility that the registered user may exist, sets the number of execution times n of the HPD user authentication processing to “n=0” to resume counting, and proceeds to the process in step S107 to execute the HPD user authentication processing again. On the other hand, when the detected number of persons becomes zero (that is, any person no longer exists) (NO), the face detection unit 210 returns to the process in step S101 to execute the person detection processing continuously in a state where no person exists (Presence=false).

Note that, in the example of HPD processing illustrated in FIG. 7, the example of stopping the HPD user authentication processing based on the fact that the number of times the HPD user authentication processing is executed has reached ten times since the presence of a person was detected by the person detection processing is described, but the number of times the HPD user authentication processing is executed before stopping the HPD user authentication processing is not limited to ten times, and it can be set to any number of times.

As described above, the information processing apparatus 1 according to one or more embodiments includes the system memory 304 (an example of a memory) which temporarily stores a program of the system, the face detection unit 210 (an example of a first processor), and the main processing unit 300 (for example, the CPU 301; an example of a second processor). The face detection unit 210 executes HPD user authentication processing (an example of face authentication processing) to detect an area of a face image (face area) with a face captured therein from a captured image captured by the imaging unit 120 and to authenticate whether or not a person of the detected face image is the registered user based on feature information (an example of information) on the detected face image and the HPD user ID (feature information on a face image of the registered user (another example of information)). The main processing unit 300 executes the program of the system to boot the system from the standby state based on the fact that the authentication by the HPD user authentication processing is successful. Further, when the authentication by the HPD user authentication processing is unsuccessful, the face detection unit 210 executes the HPD user authentication processing again, and when the HPD user authentication processing is repeatedly executed due to failures of the authentication by the HPD user authentication processing, the face detection unit 210 stops the HPD user authentication processing based on the number of times the HPD user authentication processing is executed.

Thus, when the authentication by the HPD user authentication processing is unsuccessful, since the information processing apparatus 1 stops the HPD user authentication processing based on the number of times the HPD user authentication processing is executed, rather than continuously executing the HPD user authentication processing, the information processing apparatus 1 can prevent an unregistered person from being erroneously determined to be the registered user and hence the system from being unintentionally booted even when the unregistered person is in front of the information processing apparatus 1 for a long time. Therefore, the information processing apparatus 1 can boot the system properly when the registered user approaches.

For example, the face detection unit 210 detects an area of a face image (face area) with a face captured therein from a captured image to execute the person detection processing to detect the presence of a person, and when the presence of a person is detected by the person detection processing, the face detection unit 210 moves from the person detection processing to the HPD user authentication processing. Further, the face detection unit 210 stops the HPD user authentication processing based on the fact that the number of times the HPD user authentication processing is executed has reached the preset number of times (for example, ten times) since the presence of the person was detected by the person detection processing.

Thus, since the information processing apparatus 1 executes the HPD user authentication processing when a person is present in front of the information processing apparatus 1 and stops the HPD user authentication processing based on the number of times the HPD user authentication processing is executed, rather than continuously executing the HPD user authentication processing, even in a case where authentication failures continue to occur, the information processing apparatus 1 can prevent an unregistered person from being erroneously determined to be the registered user and hence the system from being unintentionally booted even when the unregistered person is in front of the information processing apparatus 1 for a long time. Therefore, the information processing apparatus 1 can boot the system properly when the registered user approaches.

Further, when stopping the HPD user authentication processing due to failures of the authentication by the HPD user authentication processing, the face detection unit 210 moves to the person detection processing.

Thus, after stopping the HPD user authentication processing due to the fact that the unregistered person is in front of the information processing apparatus 1, the information processing apparatus 1 can detect the situation of the person present in front of the information processing apparatus 1.

Further, the face detection unit 210 determines whether or not the number of persons that exist changes when the presence of a person is detected by the person detection processing after stopping the HPD user authentication processing, and when determining that the number of persons that exist changes, the face detection unit 210 moves from the person detection processing to the HPD user authentication processing again.

Thus, when the number of persons present in front of the information processing apparatus 1 changes after stopping the HPD user authentication processing, the information processing apparatus 1 can determine whether or not the registered user exists by the HPD user authentication processing again because there is a possibility that the registered user may exist.

Further, when the presence of the person is no longer detected by the person detection processing after stopping the HPD user authentication processing, the face detection unit 210 continues the person detection processing without moving to the HPD user authentication processing, and when the presence of a person is detected, the face detection unit 210 moves from the person detection processing to the HPD user authentication processing.

Thus, even when the number of persons present in front of the information processing apparatus 1 changes after stopping the HPD user authentication processing, the information processing apparatus 1 can continue the person detection processing without performing the HPD user authentication processing unnecessarily when the presence of the person is no longer detected.

Further, the person detection processing is processing lower in power consumption than the HPD user authentication processing.

Thus, since the information processing apparatus 1 does not execute the HPD user authentication processing unnecessarily in the standby state, the information processing apparatus 1 can not only prevent an unregistered person from being erroneously determined to be the registered user, but also reduce power consumption.

For example, in the person detection processing, the frame rate when detecting an area of a face image (face area) with a face captured therein from a captured image is lower than the frame rate in the HPD user authentication processing. When moving from the person detection processing to the HPD user authentication processing and moving from the HPD user authentication processing to the person detection processing, the face detection unit 210 switches the frame rate.

Thus, the information processing apparatus 1 can reduce the frame rate when moving to the person detection processing after stopping the HPD user authentication processing to reduce power consumption. Further, when executing the HPD user authentication processing, the information processing apparatus 1 can increase the frame rate more than that in the person detection processing to perform the face authentication processing.

Further, after booting the system, the main processing unit 300 may execute login authentication processing to authenticate whether or not to allow login to the system based on the face image detected from the captured image captured by the imaging unit 120. In this case, the HPD user authentication processing executed in the standby state before booting the system is processing lower in power consumption than the login authentication processing.

Thus, the information processing apparatus 1 performs HPD user authentication processing (face authentication processing) with power consumption as little as possible in the standby state so that high-precision face authentication can be performed in the login authentication processing after booting the system.

For example, in the HPD user authentication processing executed in the standby state before booting the system, the frame rate when detecting an area of a face image with a face captured therein from a captured image is lower than that in the login authentication processing.

Thus, the information processing apparatus 1 can perform the HPD user authentication processing (face authentication processing) at a lower frame rate in the standby state with as little power consumption as possible, and perform face authentication with high precision at a higher frame rate in the login authentication processing after booting the system.

Further, the face detection unit 210 executes user registration processing to register feature information based on a face image of the user using the information processing apparatus 1 (the other example of the information) (for example, to register the feature information as the HPD user ID).

Thus, the information processing apparatus 1 can determine whether or not a person present in front of the information processing apparatus 1 is an authorized user using the information processing apparatus 1.

Further, a control method according to one or more embodiments is a control method for the information processing apparatus 1 including: the system memory 304 (the example of the memory) which temporarily stores a program of the system; the face detection unit 210 (the example of the first processor); and the main processing unit 300 (for example, the CPU 301; the example of the second processor), the control method including: a step of causing the face detection unit 210 to execute HPD user authentication processing (the example of the face authentication processing) to detect an area of a face image (face area) with a face captured therein from a captured image captured by the imaging unit 120 and to authenticate whether or not a person of the detected face image is the registered user based on feature information (the example of the information) on the detected face image and the HPD user ID (feature information (the other example of the information) on a face image of the registered user)); a step of causing the main processing unit 300 to execute the program of the system to boot the system from the standby state based on the fact that the authentication by the HPD user authentication processing is successful; a step of causing the face detection unit 210 to execute the HPD user authentication processing again when the authentication by the HPD user authentication processing is unsuccessful; and a step in which, when the HPD user authentication processing is repeatedly executed due to failures of the authentication by the HPD user authentication processing, the face detection unit 210 stops the HPD user authentication processing based on the number of times the HPD user authentication processing is executed.

Thus, when the authentication by the HPD user authentication processing is unsuccessful, since the control method for the information processing apparatus 1 stops the HPD user authentication processing based on the number of times the HPD user authentication processing is executed, rather than continuously executing the HPD user authentication processing, even in a case where authentication failures continue to occur, the control method for the information processing apparatus 1 can prevent an unregistered person from being erroneously determined to be the registered user and hence the system from being unintentionally booted even when the unregistered person is in front of the information processing apparatus 1 for a long time. Therefore, the control method for the information processing apparatus 1 can boot the system properly when the registered user approaches.

While the embodiments of this invention have been described in detail above with reference to the accompanying drawings, the specific configurations are not limited to those in the embodiments described above, and design changes are also included without departing from the scope of this invention. For example, the respective components described in the above-described embodiments can be combined arbitrarily.

Note that the imaging unit 120 may also include either one of the IR camera and the RGB camera. For example, the configuration may be such that the IR camera is used in both the HPD processing and the login authentication processing, or that the RGB camera is used in both the HPD processing and the login authentication processing.

Further, the frame rate of the imaging unit 120 in each operating state and processing is just an example, and is not limited to the example of each frame rate described above. For example, it is preferable to set the frame rates when executing the person detection processing and the HPD user authentication processing in the standby state lower than the frame rate when executing the login processing after bootup, but the values of the frame rates described above are just examples, and the values of the frame rates are not limited to these examples.

Further, in the aforementioned embodiments, the configuration example in which the imaging unit 120 is built in the information processing apparatus 1 is described, but the present invention is not limited to this example. For example, the imaging unit 120 does not have to be built in the information processing apparatus 1, which may also be attachable to the information processing apparatus 1 (for example, onto any one of the side faces 10a, 10b, 10c, and the like) and communicably connected to the information processing apparatus 1 wirelessly or by wire as an external accessory of the information processing apparatus 1.

Further, the CPU 301 and the chipset 303 (the example of the second processor) may be configured as individual processors, or configured to be integrated as one processor.

Further, in the aforementioned embodiments, the example in which the face detection unit 210 (the example of the first processor) is provided separated from the chipset 303 is illustrated, but some or all of the functions of the face detection unit 210 may be provided in the chipset 303, or may be provided in a processor integrated with the chipset 303. Further, the face detection unit 210, the chipset 303, and the CPU 301 may be configured to be integrated as one processor. Further, some or all of the functions of the face detection unit 210 may be provided in the EC 200.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the information processing apparatus 1, or delivery servers for delivering respective divided pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions of the information processing apparatus 1 in the embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

1 information processing apparatus
10 first chassis
20 second chassis
15 hinge mechanism
110 display unit
120 imaging unit
140 power button
150 input device
151 keyboard
153 touch pad
160 communication unit
170 storage unit
200 EC
210 face detection unit
211 face detection processing unit
212 face authentication processing unit
213 HPD user ID registration unit
214 HPD processing unit
300 main processing unit
301 CPU
302 GPU
303 chipset
304 system memory
310 system processing unit
311 operation control unit
312 authentication processing unit
330 HPD control processing unit
331 operation instruction unit
332 authentication result notification unit
400 power supply unit

What is claimed is:

1. An information processing apparatus comprising:
a memory which temporarily stores a program of a system;
a first processor which executes face authentication processing to detect an area of a face image with a face captured therein from a captured image captured by an imaging unit and to authenticate whether or not a person of the detected face image is a registered user based on information on the detected face image and information on a face image of the registered user; and
a second processor which executes the program of the system to boot the system from a standby state based on a fact that authentication by the face authentication processing is successful,
wherein when the authentication by the face authentication processing is unsuccessful, the first processor executes the face authentication processing again, and when executing the face authentication processing repeatedly due to failures of the authentication by the face authentication processing, the first processor stops the face authentication processing based on the number of times the face authentication processing is executed.

2. The information processing apparatus according to claim 1, wherein
the first processor executes person detection processing to detect presence of a person by detecting the area of the face image with the face captured therein from the captured image, and when the presence of a person is detected by the person detection processing, the first processor moves from the person detection processing to the face authentication processing, and
the first processor stops the face authentication processing based on a fact that the number of times the face authentication processing is executed has reached a preset number of times since the presence of the person was detected by the person detection processing.

3. The information processing apparatus according to claim 2, wherein when stopping the face authentication processing due to failures of the authentication by the face authentication processing, the first processor moves to the person detection processing.

4. The information processing apparatus according to claim 3, wherein when the presence of a person is detected by the person detection processing after stopping the face authentication processing, the first processor determines whether or not the number of persons that exist changes, and when determining that the number of persons that exist changes, the first processor moves from the person detection processing to the face authentication processing again.

5. The information processing apparatus according to claim 4, wherein when the presence of the person is no longer detected by the person detection processing after stopping the face authentication processing, the first processor continues the person detection processing without moving to the face authentication processing, and when the presence of a person is detected, the first processor moves from the person detection processing to the face authentication processing.

6. The information processing apparatus according to claim 2, wherein the person detection processing is processing lower in power consumption than the face authentication processing.

7. The information processing apparatus according to claim 2, wherein
a frame rate when detecting the area of the face image with the face captured therein from the captured image in the person detection processing is lower than that in the face authentication processing, and
when moving from the person detection processing to the face authentication processing and from the face authentication processing to the person detection processing, the first processor switches the frame rate.

8. The information processing apparatus according to claim 1, wherein
the second processor executes login authentication processing to authenticate whether or not to allow login to the system based on the face image detected from the captured image captured by the imaging unit after booting the system, and
the face authentication processing executed in the standby state before booting the system is processing lower in power consumption than that in the login authentication processing.

9. The information processing apparatus according to claim 8, wherein the frame rate when detecting the area of the face image with the face captured therein from the captured image in the face authentication processing executed in the standby state before booting the system is lower than that in the login authentication processing.

10. The information processing apparatus according to claim 1, wherein the first processor executes user registration processing to register information based on a face image of a user using the information processing apparatus.

11. A control method for an information processing apparatus including a memory which temporarily stores a program of a system, a first processor, and a second processor, the control method comprising:
a step of causing the first processor to execute face authentication processing to detect an area of a face image with a face captured therein from a captured image captured by an imaging unit and to authenticate whether or not a person of the detected face image is a registered user based on information on the detected face image and information on a face image of the registered user;
a step of causing the second processor to execute the program of the system to boot the system from a standby state based on a fact that authentication by the face authentication processing is successful;
a step of causing the first processor to execute the face authentication processing again when the authentication by the face authentication processing is unsuccessful; and
a step in which, when executing the face authentication processing repeatedly due to failures of the authentication by the face authentication processing, the first processor stops the face authentication processing based on the number of times the face authentication processing is executed.
